(19) United States
(12) Patent Application Publication
(10) Pub. No.: US 2026/0225008 A1
(43) Pub. Date: Aug. 6, 2026

(54) SWING FILTER-LINKED DEVICE AND LIQUID FILTRATION EQUIPMENT

(71) Applicant: BENQ CORPORATION, Taipei City (TW)

(72) Inventor: Chin-Fu Chiang, Taipei City (TW)

(73) Assignee: BENQ CORPORATION, Taipei City (TW)

(21) Appl. No.: 19/369,389

(22) Filed: Oct. 27, 2025

(30) Foreign Application Priority Data
Feb. 5, 2025 (TW) 114104117

(51) Int. Cl. B01D 29/56

(52) U.S. Cl. CPC B01D 29/56

(57) ABSTRACT

A swing filter-link device applied to a water filtration equipment can prevent a filter unit from liquid leakage when swing. The swing link device includes a first connection tube and a fixing component. The first connection tube is inserted into an opening of the filter unit and includes a first contacting portion. The first connection tube is rotatably assembled with the fixing component, and a rotation axis of the first connection tube is perpendicular to a structurally longitudinal direction of the filter unit. The fixing component includes a first hole structure and a first baffle. The first connection tube passes through the first hole structure to insert into the opening. The first baffle is disposed on an edge of the first hole structure adjacent to the filter unit, so as to contact the first contacting portion for constraining a movement of the first connection tube relative to the filter unit.

### BACKGROUND OF THE INVENTION

### 1. FIELD OF THE INVENTION

The present invention relates to a filter-linked device and liquid filtration equipment, and more particularly, to a swing filter-linked device of allowing a filter unit to swing arbitrarily without liquid leakage and related liquid filtration equipment.

### 2. DESCRIPTION OF THE PRIOR ART

With the advanced technology, the consumer uses various water filtration devices to improve the quality of life. There are many types of conventional water filtration devices. The appearance of a simple water filtration device is like a kettle, and water is directly collected from the faucet for filtering. The wall-mounted water filtration device is installed on the water pipeline, and the filtered water flows directly from the faucet. The filter unit of the simple water filtration device is easy to disassemble and assemble, but is inconvenient to use as a whole. The use process of the wall-mounted water filtration device is convenient, but the wall-mounted water filtration device is usually installed under the sink, and disassembly and assembly of the filter unit is inconvenient. The conventional filter connection device is installed between the filter unit and the water pipe via the two-way connecting pipe, and the filter unit is often loosed from the water pipe in the engaged state and the axis of the filter unit is skewed to cause leakage. The conventional filter connection device only solves the problem of positioning the filter unit relative to the water pipe at a specific angle; for example, the conventional filter connection device is only fixed on the wall above the filter unit to lock the relative position. If the filter unit is skewed due to unexpected vibration, there is a risk of leakage even the filter unit in the engaged state. Therefore, design of a filter-linked device that allows the filter unit to swing arbitrarily without liquid leakage is an important issue in the related mechanical design industry.

### SUMMARY OF THE INVENTION

The present invention provides a swing filter-linked device of allowing a filter unit to swing arbitrarily without liquid leakage and related liquid filtration equipment for solving above drawbacks.

According to the claimed invention, a swing filter-linked device of preventing a filter unit from liquid leakage when swing can include a first connection tube, a fixing component and a first constraining component. The first connection tube is configured to insert into an opening of the filter unit and comprising a first contacting portion. The fixing component is rotatably assembled with the first connection tube. A rotation axis of the first connection tube is perpendicular to a structurally longitudinal direction of the filter unit. The fixing component includes a first hole structure and a first baffle. The first connection tube passes through the first hole structure to insert into the opening. The first baffle is disposed on an edge of the first hole structure adjacent to the filter unit and configured to abut against the first contacting portion. The first constraining component is disposed on a side of the fixing component relative to the filter unit and attached to the fixing component. The first baffle and the first constraining component are configured to constrain a movement of the first connection tube relative to the filter unit.

The swing filter-linked device of the present application can insert the first connection tube and the second connection tube coaxially into the hole structures of the fixing component and the openings of the filter unit. The contacting portions of the first connection tube and the second connection tube can respectively abut against the first baffle and the second baffle of the fixing component. The reaching portions of the first connection tube and the second connection tube can respectively abut against the opposite outer surfaces of the filter unit. Further, the first constraining component and the second constraining component can be respectively buckled with two sides of the fixing component, and press the first connection tube and the second connection tube to prevent the first connection tube and the second connection tube from being separated from the fixing component and the filter unit. For connecting the multiple filter units, the latch end of the bridging component can be inserted into the engaging recess of the fixing component, and the second connection tube and another connection tube can be coaxially inserted into the two openings of another filter unit, and other constraining component can be engaged with the fixing end of the bridging component to achieve the purpose of concatenation. The swing filter-linked device of the present application can use the fixing component to insert the connection tubes coaxially into the openings of the filter unit, and press the detachable constraining component onto the connection tube and the fixing component in a coaxial manner. The bridging component can be optionally used to help the fixing component to connect the multiple filter units with each other, so that the filter unit can be swung and conveniently replaced and have preferred leak-proof reliability.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an appearance diagram of a swing filter-linked device according to an embodiment of the present application.

FIG. 2 is an exploded diagram of a part of the swing filter-linked device according to the embodiment of the present application.

FIG. 3 is a sectional view of the swing filter-linked device according to the embodiment of the present application.

FIGS. 4 and FIG. 5 are sectional views of other parts of the swing filter-linked device according to the embodiment of the present application.

FIG. 6 is a diagram of a component of the swing filter-linked device according to the embodiment of the present application.

FIG. 7 is a diagram of the swing filter-linked device 10 rotated relative to the filter unit to another angle according to the embodiment of the present application.

### DETAILED DESCRIPTION

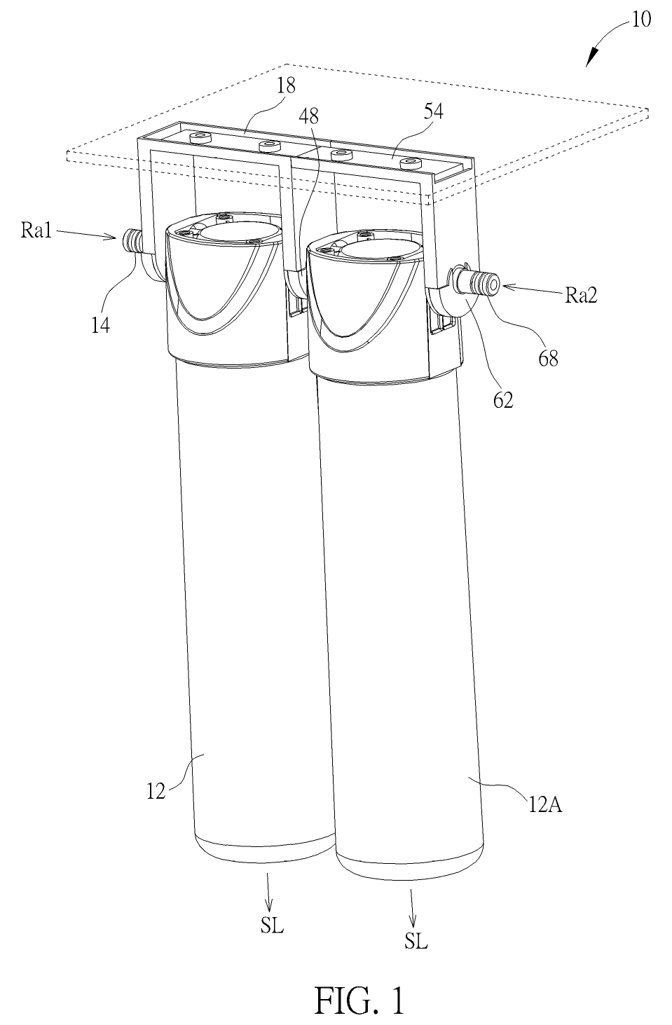

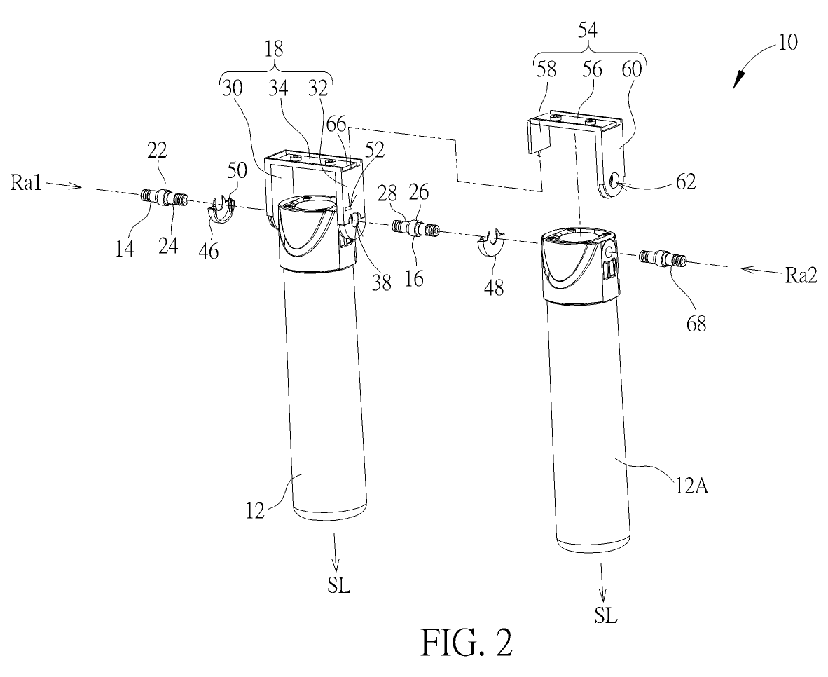

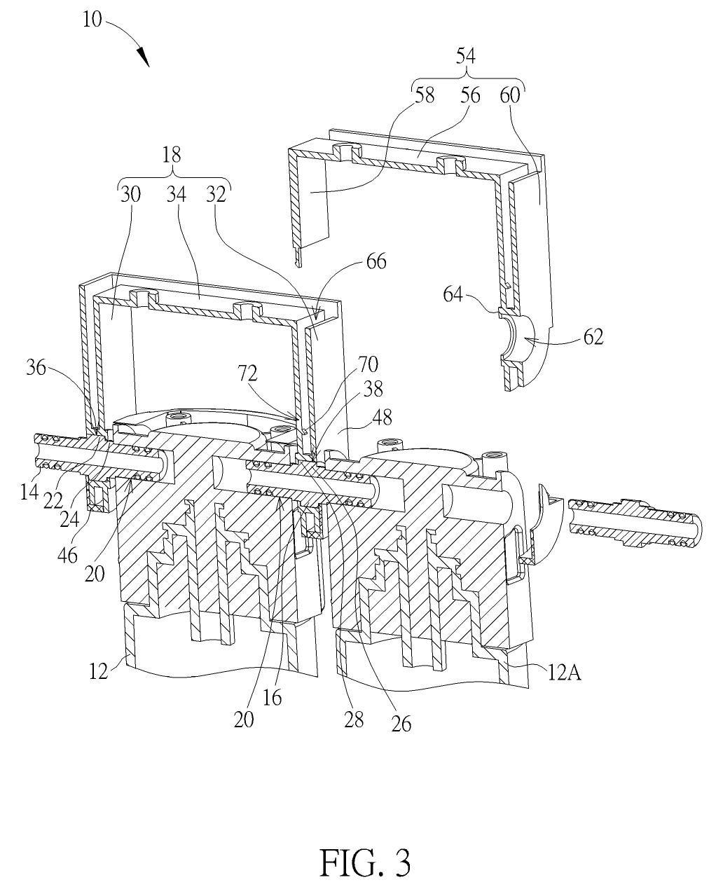

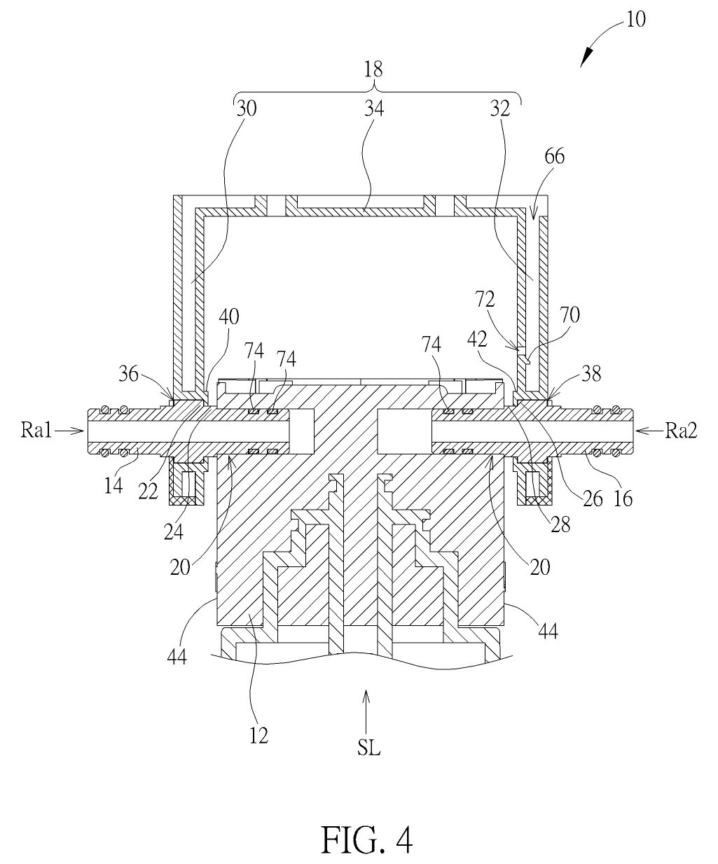

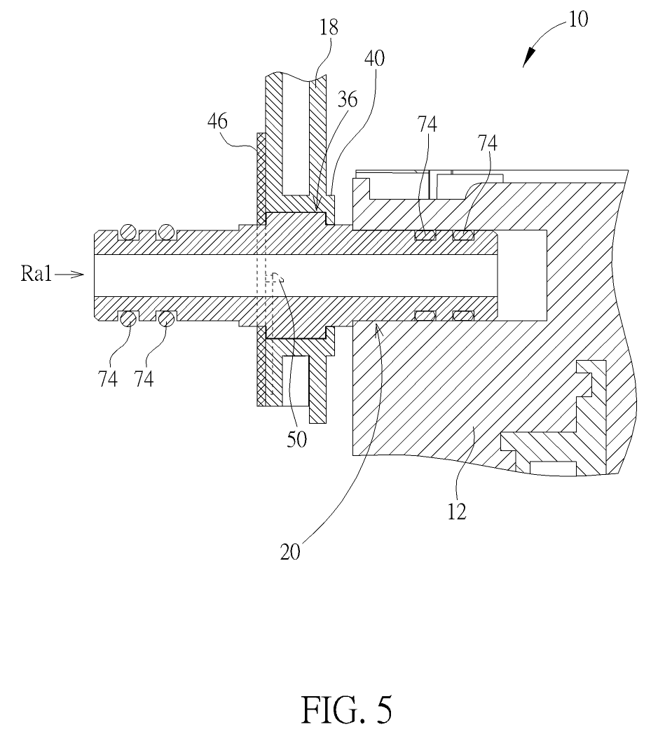

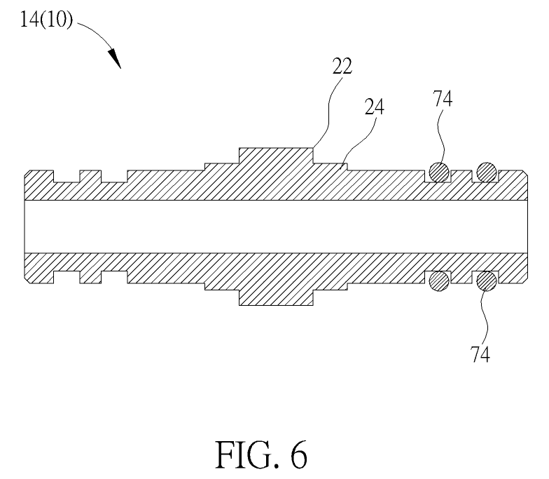

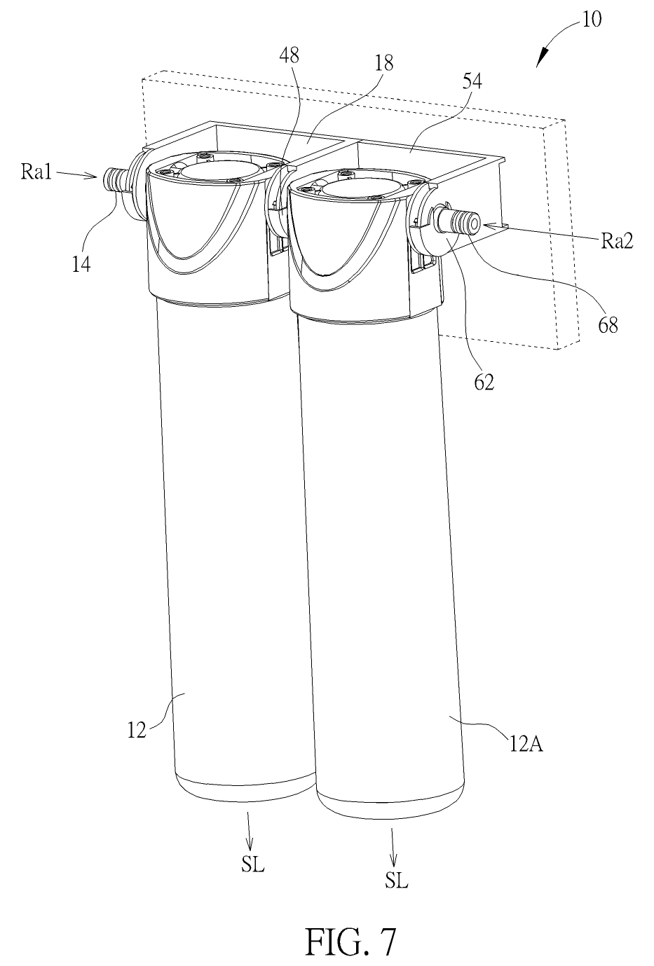

Please refer to FIGS. 1 and 7 . FIG. 1 is an appearance diagram of a swing filter-linked device 10 according to an embodiment of the present application. FIG. 2 is an exploded diagram of a part of the swing filter-linked device 10 according to the embodiment of the present application. FIG. 3 is a sectional view of the swing filter-linked device 10 according to the embodiment of the present application. FIGS. 4 and 5 are sectional views of other parts of the swing filter-linked device 10 according to the embodiment of the present application. FIG. 6 is a diagram of a component of the swing filter-linked device 10 according to the embodiment of the present application. FIG. 7 is a diagram of the swing filter-linked device 10 rotated relative to the filter unit 12 to another angle according to the embodiment of the present application. The swing filter-linked device 10 can prevent the filter unit 12 from liquid leakage when being swung, and the filter unit 12 can be easily replaced regardless of any angle to which the filter unit 12 is swung. As shown in FIGS. 1 and 7, the swing filter-linked device 10 can be fixed on a wall (such as a dotted pattern) near by the top or the lateral of the filter unit 12, and can be suitable for various environments and have preferred product competition.

The swing filter-linked device 10 can include a first connection tube 14, a second connection tube 16 and a fixing component 18. The first connection tube 14 and the second connection tube 16 can be assembled with the fixing component 18 in a rotatable manner, and can be respectively inserted into two openings 20 of the filter unit 12, such as an outlet and an inlet of the filter unit 12. The first connection tube 14 can include a first contacting portion 22 and a first reaching portion 24. Two ends of the first connection tube 14 can be respectively inserted into the openings 20 of different filter units 12. A waterproof gasket 74 can be disposed on each end of the first connection tube 14 to fill inside a gap between the first connection tube 14 and the opening 20 for preventing the liquid leakage. The first contacting portion 22 and the first reaching portion 24 can be disposed on a middle section of the first connection tube 14. The first reaching portion 24 can be disposed adjacent to the first contacting portion 22, and extended towards two ends of the first connection tube 14.

The second connection tube 16 can include a second contacting portion 26 and a second reaching portion 28. Two ends of the second connection tube 16 can be respectively inserted into the openings 20 of different filter units 12. The second contacting portion 26 and the second reaching portion 28 can be disposed on a middle section of the second connection tube 16. The second reaching portion 28 can be disposed adjacent to the second contacting portion 26, and extended towards two ends of the second connection tube 16. Generally, structural features of the first connection tube 14 can be the same as or similar to structural features of the second connection tube 16. The first connection tube 14 and/or the second connection tube 16 can be preferably designed to be bilaterally symmetrical, but actual application is not limited thereto.

The fixing component 18 can include a first section 30, a second section 32 and a third section 34 connected with each other. The first section 30 and the second section 32 can be respectively disposed on two opposite ends of the third section 34 in a symmetrical manner, and the fixing component 18 can be designed as a U-type structure. The fixing component 18 can include a first hole structure 36, a second hole structure 38, a first baffle 40 and a second baffle 42. The first hole structure 36 can be disposed on the first section 30. The first baffle 40 can be disposed on an edge of the first hole structure 36 adjacent to the filter unit 12. The second hole structure 38 can be disposed on the second section 32. The second baffle 42 can be disposed on an edge of the second hole structure 38 adjacent to the filter unit 12.

During assembly of the swing filter-linked device 10, the fixing component 18 can be disposed on the filter unit 12, and the first hole structure 36 and the second hole structure 38 of the fixing component 18 can respectively align with the openings 20 of the filter unit 12. Then, the first connection tube 14 can pass through the first hole structure 36 and be inserted into one opening 20 of the filter unit 12, and the second connection tube 16 can pass through the second hole structure 38 to insert into another opening 20 of the filter unit 12. The first contacting portion 22 of the first connection tube 14 and the second contacting portion 26 of the second connection tube 16 can be respectively blocked by the first baffle 40 and the second baffle 42 of the fixing component 18, so as to constrain movements of the first connection tube 14 and the second connection tube 16 relative to the filter unit 12 for constraint effect.

Besides, the first reaching portion 24 of the first connection tube 14 can pass through the first hole structure 36 of the fixing component 18 and abut against an outer surface 44 of the filter unit 12. The second reaching portion 28 of the second connection tube 16 can pass through the second hole structure 38 of the fixing component 18 and abut against another outer surface 44 of the filter unit 12. A rotation axis Ra1 of the first connection tube 14 can be perpendicular to a structurally longitudinal direction SL of the filter unit 12, and a rotation axis Ra2 of the second connection tube 16 can be perpendicular to the structurally longitudinal direction SL of the filter unit 12. Therefore, the rotation axis Ra1 of the first connection tube 14 within the first hole structure 36 can align with the rotation axis Ra2 of the second connection tube 16 within the second hole structure 38, so as to ensure that the liquid inlet and the liquid outlet of the swing filter-linked device 10 that are cooperated with the filter unit 12 can be coaxial.

Moreover, the swing filter-linked device 10 can further include a first constraining component 46 and a second constraining component 48 respectively disposed on two sides of the fixing component 18 relative to the filter unit 12. The first constraining component 46 and the second constraining component 48 can be attached to the fixing component 18, and can prevent the first connection tube 14 and the second connection tube 16 from be separated from the fixing component 18. The first constraining component 46 and the second constraining component 48 may be respectively attached to two sides of the fixing component 18, and press the first connection tube 14 and the second connection tube 16, for preventing the first connection tube 14 and the second connection tube 16 from being separated from the fixing component 18 and the filter unit 12. Features of the first constraining component 46 can be the same as or similar to features of the second constraining component 48. Take the first constraining component 46 as an example, the first constraining component 46 can include a first buckling portion 50 used to insert into a buckled slot (which is not marked in the figures) of the fixing component 18, and the first constraining component 46 can be stably positioned on the fixing component 18. The foresaid buckled slot can be disposed inside the first hole structure 36 of the fixing component 18, or on an edge or an outer surface of the first section 30; however, actual application is not limited thereto.

Accordingly, the fixing component 18 can optionally include a first releasing hole 52 formed on position of the first section 30 and/or the second section 32 adjacent to the buckled slot. The user can insert an external component (which is not marked in the figures) into the first releasing hole 52 to push the first buckling portion 50 away from the buckled slot, and the first constraining component 46 can be disassembled from the fixing component 18. Generally, the external component can be a thin rod, and a rod diameter of the thin rod can be smaller than or equal to an aperture of the first releasing hole 52. As long as the aperture of the first releasing hole 52 conforms to an actual demand, the external component may also be a common object such as a pen top, a screw or a finger, and possible variation of the external component can be omitted herein for simplicity.

The fixing component 18 can be used to assemble the first connection tube 14 and the second connection tube 16 with the filter unit 12, and the swing filter-linked device 10 of the present application can have a function of connecting multiple filter units 12 in series. For example, the swing filter-linked device 10 can further include a bridging component 54 detachably connected to the fixing component 18, and another filter unit 12A can be disposed adjacent to the filter unit 12 accordingly. The bridging component 54 can include a main body 56, a latch end 58 and a fixing end 60. The latch end 58 and the fixing end 60 can be respectively disposed on two opposite sides of the main body 56. The fixing end 60 can include a third hole structure 62 and a third baffle 64. Structures and functions of the third hole structure 62 and the third baffle 64 can be the same as ones of the first hole structure 36 and the first baffle 40, and/or the second hole structure 38 and the second baffle 42 of the fixing component 18, and a detailed description is omitted herein for simplicity.

The fixing component 18 can include an engaging recess 66 disposed on the first section 30 of the fixing component 18 where on the first hole structure 36 is disposed, or on the second section 32 of the fixing component 18 where on the second hole structure 38 is disposed. Position of the engaging recess 66 can depend on an assembly manner of the bridging component 54 and the fixing component 18. A shape of the engaging recess 66 can be designed based on a shape of the latch end 58, and a detailed description is omitted herein for simplicity. For connecting the multiple filter units 12, the latch end 58 of the bridging component 54 can be detachably inserted into the engaging recess 66 of the fixing component 18 to engage with an engaging portion 70 of the fixing component 18. The fixing end 60 of the bridging component 54 can be fixed to a side of the filter unit 12A opposite to the filter unit 12. The third hole structure 62 of the fixing end 60 can be passed through by another connection tube 68, and the connection tube 68 can be blocked by the third baffle 64 of the fixing end 60 to constrain a movement of the connection tube 68 relative to the filter unit 12A, so as to achieve the purpose of concatenation. For rapid disassembly of the bridging component 54, a second releasing hole 72 can be formed on the fixing component 18. The second releasing hole 72 can be disposed on position of the first section 30 and/or the second section 32 adjacent to the engaging portion 70 inside the engaging recess 66. The user can insert the external component (which is not marked in the figures) into the second releasing hole 72 to push and separate the latch end 58 from the engaging portion 70 inside the engaging recess 66, and the bridging component 54 can be disassembled from the fixing component 18.

In conclusion, the swing filter-linked device of the present application can insert the first connection tube and the second connection tube coaxially into the hole structures of the fixing component and the openings of the filter unit. The contacting portions of the first connection tube and the second connection tube can respectively abut against the first baffle and the second baffle of the fixing component. The reaching portions of the first connection tube and the second connection tube can respectively abut against the opposite outer surfaces of the filter unit. Further, the first constraining component and the second constraining component can be respectively buckled with two sides of the fixing component, and press the first connection tube and the second connection tube to prevent the first connection tube and the second connection tube from being separated from the fixing component and the filter unit. For connecting the multiple filter units, the latch end of the bridging component can be inserted into the engaging recess of the fixing component, and the second connection tube and another connection tube can be coaxially inserted into the two openings of another filter unit, and other constraining component can be engaged with the fixing end of the bridging component to achieve the purpose of concatenation.

Comparing to the prior art, the swing filter-linked device of the present application can use the fixing component to insert the connection tubes coaxially into the openings of the filter unit, and press the detachable constraining component onto the connection tube and the fixing component in a coaxial manner. The bridging component can be optionally used to help the fixing component to connect the multiple filter units with each other, so that the filter unit can be swung and conveniently replaced and have preferred leak-proof reliability. In addition, the present application can further include liquid filtration equipment which includes the filter unit and the swing filter-linked device mentioned as above.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A swing filter-linked device of preventing a filter unit from liquid leakage when swing, the swing filter-linked device comprising:
a first connection tube configured to insert into an opening of the filter unit and comprising a first contacting portion;
a fixing component rotatably assembled with the first connection tube, a rotation axis of the first connection tube being perpendicular to a structurally longitudinal direction of the filter unit, the fixing component comprising:
a first hole structure, the first connection tube passing through the first hole structure to insert into the opening; and
a first baffle disposed on an edge of the first hole structure adjacent to the filter unit and configured to abut against the first contacting portion; and
a first constraining component disposed on a side of the fixing component relative to the filter unit and attached to the fixing component, the first baffle and the first constraining component being configured to constrain a movement of the first connection tube relative to the filter unit.

2. The swing filter-linked device of claim 1, wherein the swing filter-linked device further comprises:
a second connection tube configured to insert into another opening of the filter unit and comprising a second contacting portion; and
the fixing component further comprising:
a second hole structure, the second connection tube passing through the second hole structure to insert into the another opening; and
a second baffle disposed on an edge of the second hole structure adjacent to the filter unit and configured to abut against the second contacting portion for constraining a movement of the second connection tube relative to the filter unit.

3. The swing filter-linked device of claim 2, wherein the fixing component comprises a first section, a second section and a third section, the first section and the second section are respectively connected to two opposite ends of the third section in a symmetrical manner, the first hole structure is disposed on the first section, the second hole structure is disposed on the second section, the rotation axis of the first connection tube in the first hole structure aligns with a rotation axis of the second connection tube in the second hole structure.

4. The swing filter-linked device of claim 2, wherein the swing filter-linked device further comprises a second constraining component, the first constraining component and the second constraining component are respectively disposed on two sides of the fixing component relative to the filter unit; the second constraining component is attached to the fixing component, the second baffle and the second constraining component are configured to constrain a movement of the second connection tube relative to the filter unit.

5. The swing filter-linked device of claim 1, wherein the first connection tube further comprises a first reaching portion disposed adjacent to the first contacting portion, and configured to pass through the first hole structure and abut against an outer surface of the filter unit.

6. The swing filter-linked device of claim 5, wherein the first constraining component comprises a first buckling portion configured to insert into a corresponding buckled slot of the fixing component for positioning the first constraining component on the side of the fixing component; the fixing component comprises a first releasing hole formed on a position adjacent to the corresponding buckled slot, an external component is inserted into the first releasing hole so that the external component pushes the first buckling portion to separate from the corresponding buckled slot.

7. The swing filter-linked device of claim 1, wherein the swing filter-linked device further comprises a bridging component detachably connected with the fixing component so that another filter unit is connected adjacent to the filter unit; the fixing component comprises an engaging recess disposed on a section of the fixing component where on the first hole structure is disposed, an end of the bridging component is detachably inserted into the engaging recess to connect with the fixing component; the bridging component comprises a main body, a latch end and a fixing end, the latch end and the fixing end are respectively disposed on two opposite sides of the main body, the latch end is detachably inserted into the engaging recess, the fixing end is fixed on a side of the another filter unit relative to the filter unit.

8. The swing filter-linked device of claim 7, wherein the fixing end comprises a third hole structure and a third baffle, the third hole structure allows passing of another connection tube, the third baffle abuts against the another connection tube to constrain a movement of the another connection tube relative to the another filter unit.

9. The swing filter-linked device of claim 7, wherein the fixing end further comprises a second releasing hole formed on a position adjacent to the engaging recess, an external component is inserted into the second releasing hole so that the external component pushes the latch end to separate from the engaging recess.

10. A liquid filtration equipment comprising:
a filter unit; and
a swing filter-linked device of preventing the filter unit from liquid leakage when swing, the swing filter-linked device comprising:
a first connection tube configured to insert into an opening of the filter unit and comprising a first contacting portion;
a fixing component rotatably assembled with the first connection tube, a rotation axis of the first connection tube being perpendicular to a structurally longitudinal direction of the filter unit, the fixing component comprising:
a first hole structure, the first connection tube passing through the first hole structure to insert into the opening; and
a first baffle disposed on an edge of the first hole structure adjacent to the filter unit and configured to abut against the first contacting portion; and
a first constraining component disposed on a side of the fixing component relative to the filter unit and attached to the fixing component, the first baffle and the first constraining component being configured to constrain a movement of the first connection tube relative to the filter unit.

11. The liquid filtration equipment of claim 10, wherein the swing filter-linked device further comprises:
a second connection tube configured to insert into another opening of the filter unit and comprising a second contacting portion; and
the fixing component further comprising:
a second hole structure, the second connection tube passing through the second hole structure to insert into the another opening; and
a second baffle disposed on an edge of the second hole structure adjacent to the filter unit and configured to abut against the second contacting portion for constraining a movement of the second connection tube relative to the filter unit.

12. The liquid filtration equipment of claim 11, wherein the fixing component comprises a first section, a second section and a third section, the first section and the second section are respectively connected to two opposite ends of the third section in a symmetrical manner, the first hole structure is disposed on the first section, the second hole structure is disposed on the second section, the rotation axis of the first connection tube in the first hole structure aligns with a rotation axis of the second connection tube in the second hole structure.

13. The liquid filtration equipment of claim 11, wherein the swing filter-linked device further comprises a second constraining component, the first constraining component and the second constraining component are respectively disposed on two sides of the fixing component relative to the filter unit; the second constraining component is attached to the fixing component, the second baffle and the second constraining component are configured to constrain a movement of the second connection tube relative to the filter unit.

14. The liquid filtration equipment of claim 10, wherein the first connection tube further comprises a first reaching portion disposed adjacent to the first contacting portion, and configured to pass through the first hole structure and abut against an outer surface of the filter unit.

15. The liquid filtration equipment of claim 14, wherein the first constraining component comprises a first buckling portion configured to insert into a corresponding buckled slot of the fixing component for positioning the first constraining component on the side of the fixing component; the fixing component comprises a first releasing hole formed on a position adjacent to the corresponding buckled slot, an external component is inserted into the first releasing hole so that the external component pushes the first buckling portion to separate from the corresponding buckled slot.

16. The liquid filtration equipment of claim 10, wherein the swing filter-linked device further comprises a bridging component detachably connected with the fixing component so that another filter unit is connected adjacent to the filter unit; the fixing component comprises an engaging recess disposed on a section of the fixing component where on the first hole structure is disposed, an end of the bridging component is detachably inserted into the engaging recess to connect with the fixing component; the bridging component comprises a main body, a latch end and a fixing end, the latch end and the fixing end are respectively disposed on two opposite sides of the main body, the latch end is detachably inserted into the engaging recess, the fixing end is fixed on a side of the another filter unit relative to the filter unit.

17. The liquid filtration equipment of claim 16, wherein the fixing end comprises a third hole structure and a third baffle, the third hole structure allows passing of another connection tube, the third baffle abuts against the another connection tube to constrain a movement of the another connection tube relative to the another filter unit.

18. The liquid filtration equipment of claim 16, wherein the fixing end further comprises a second releasing hole formed on a position adjacent to the engaging recess, an external component is inserted into the second releasing hole so that the external component pushes the latch end to separate from the engaging recess.
